(19) United States
(12) Patent Application Publication
(10) Pub. No.: US 2006/0121177 A1
(43) Pub. Date: Jun. 8, 2006

(54) Process for pure aquatic ham or chinese ham containing fish

(76) Inventor: Shan Wang, Beijing (CN)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/524,200

(22) PCT Filed: Sep. 13, 2002
(86) PCT No.: PCT/CN02/00652

§ 371 Date: Jul. 29, 2005

(30) Foreign Application Priority Data
Aug. 14, 2002 (CN) 02128810.0

(51) Int. Cl. A23L 1/325

(52) U.S. Cl. 426/643

(57) ABSTRACT

The present invention relates to pure aquatic ham sausage or western style ham sausage containing fish, which made from pure aquatic meat. The ham sausage or western style ham sausage according to the invention is produced by using the minced cephalopod aquatic meat as a binding agent, mixing with fish as a main material, adding flavorings to the mixture, and processing by conventional methods, wherein the cephalopod aquatic meat comprise 8-95% of the total weight. The present invention make use of high binding ability of the cephalopod aquatic to overcome the defects of the fish which difficult to processed due to its high moisture content and short fibres, and use cephalopod aquatic meat instead of animal and bird meat in the ham sausage or western style ham sausage using chopped fish as raw material, making it become possible that the pure aquatic ham sausage or western style ham sausage can be made. The present invention provide a new way to process aquatic, keep the original flavor and nutrition of aquatic animal to maximum extent and the ham sausage or western style ham sausage obtained is more delicious and better in taste comparing the existing aquatic ham sausage or western style ham sausage prepared with animal and bird meat.

### FIELD OF THE INVENTION

The present invention relates to pure aquatic animal meat ham sausage or western style ham sausage containing fish and the process thereof.

### BACKGROUND OF THE INVENTION

Aquatic animal meat has high nutritive value and delicate flavor, and people like eating it. Recently, it becomes gradually a fashion to eat more aquatic products and less animal and poultry meat. The conventional process of preparing aquatic products include curing, smoking, tinning etc, or transporting the refrigerated aquatic products to meet the needs of the people who live in the place no aquatic product there. Recently, the technology for preparing ham sausage or western style ham sausage with aquatic animal meat is developed greatly, which meets people's needs to some extent. But in the prior art, the ham sausage or western style ham sausage is prepared by mixing the starch and animal and poultry meat with hashed or mashed aquatic animal meat, then preparing the aquatic animal meat ham sausage or western style ham sausage by the conventional ham sausage or western style ham sausage processing. The defects induced by the process are no distinct flavour of aquatic animal meat, dryness and acerbity in taste, bad elasticity and single taste, so people can not feel that there exists aquatic animal meat in the ham sausage or western style ham sausage when they eat the ham sausage or western style ham sausage made by the conventional method. In the meantime, the ham sausage or western style ham sausage contains more fat and cholesterol which results from the adding of some animal and poultry meat.

### SUMMARY OF THE INVENTION

One object of the invention is to make use of the high binding ability of the cephalopod aquatic animal meat, to overcome the defects of the aquatic animal meat being shaped difficultly which results from its more moisture content and short fibres. The invention utilizes cephalopod aquatic animal meat instead of animal and poultry meat in the ham sausage or western style ham sausage in which fish meat mash used as raw material. The invention combines the process of preparing aquatic product with that of preparing conventional meat. The ham sausage or western style ham sausage with scientific formulation of the invention is prepared by the unique process. The present invention prepares tasteful and nutritive pure aquatic animal meat ham sausage or western style ham sausage containing fish, which gets rid of the conventional process for preparing aquatic animal meat ham sausage or western style ham sausage by use of animal and poultry meat as binding agent. Furthermore, the invention can be used in large scale, and the sources of raw materials used in the invention are broad. The invention provides a new method for processing aquatic product.

Another object of the invention is to keep the original nutrition and flavor of aquatic in the ham sausage or western style ham sausage to maximum extent by using aquatic animal meat with a certain shape as raw material and steaming or cooking at low temperature, so that the ham sausage or western style ham sausage of the present invention is more delicious and better in taste than the aquatic animal meat ham sausage or western style ham sausage prepared by the fish meat mash and animal and poultry meat. Thus the aquatic animal meat ham sausage or western style ham sausage of the present invention will be true and tasteful aquatic animal meat ham sausage or western style ham sausage containing fish and people can appreciate the existence of the aquatic animal meat.

To achieve the aforesaid purposes, the technical solutions of this invention are as follows:

The technical solution of the pure aquatic animal meat ham sausage or western style ham sausage containing fish is as follows: selecting minced cephalopod aquatic animal meat as binding agent, mixing it with fish meat, the mixture is used as main material, and adding seasonings as subsidiary materials into the mixture, and then preparing pure aquatic animal meat ham sausage or western style ham sausage containing fish by conventional methods, wherein the cephalopod aquatic animal meat is 8-95% of the total weight, preferably 25-60%, more preferably 30-50%, of the total weight.

The cephalopod aquatic animals include Todarodes pacificus, Sepia esculenta, Loligo japonica, Sepiella maindroni, Doryteuthis bleekeri, Sepioteuthis lessoniana, Octopus variabilis, Octopus ochellatus and Octopus vulgaris.

The processing method of cephalopod aquatic animal meat described above includes steps: selecting a certain amount of cephalopod aquatic animal meat to be rough processed, removing inedible portion, then cutting edible portion into block, strip, slice or particle with length of 2-100 mm, width of 2-100 mm and thickness of 2-40 mm; then curing them with suitable amount of seasonings for 2-48 hours; the said seasonings used in curing process include soya sauce, spicery, ground spices, paprika powder, etc.

The preparing method for the aforesaid pure aquatic animal meat ham sausage or western style ham sausage containing fish includes steps: mixing the processed cephalopod aquatic animal meat with fish meat, and adding subsidiary materials according to different tastes by conventional technology. The weight ratios of the subsidiary materials are: soya sauce 0-8, refined salt 0.5-5, sugar 1-10, soya protein or starch 0-8, carrageenan 1-5, spicery 0.01-5, thickener 0.01-5. Mixing the above raw materials uniformly and filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

Aforesaid fish meat can be fish mash or fish block. Fish mash is processed by conventional method. The method for preparing fish block include steps: selecting a certain amount of fish to be rough processed, removing head, gut and scale of the fish, then salting the fish with suitable amount of salt or curing the fish with suitable amount of seasonings, drying the salted or cured fish by airing in shady and cool place for 24 hr or by heating, steaming the dried fish for 15-30 minutes, removing fish bone and foreign materials after cooling, and then cutting the fish into block, strip or slice with length of 2-100 mm, width of 2-100 mm, and thickness of 2-40 mm.

The fish block can also be processed by steps as follows: curing the fish with water, salt and spicery for 0.5-12 hours, steaming or cooking and then removing inedible portion, cutting edible portion into block, strip or slice with length of 2-100 mm, thickness of 2-40 mm, and width of 2-100 mm.

The fish block can be raw, ready-cooked, smoked and/or dried, and its shape can be block, strip or slice; its size can be 2-100 mm in length, 2-40 mm in thickness and 2-100 mm in width.

The advantages of the present invention include: remaining the original flavor and nutrition of the aquatic animal meat to maximum extent, being better in taste and having more nutrition than conventional aquatic animal meat ham sausage or western style ham sausage using fish meat mash and animal and poultry meat as raw material. The aquatic animal meat ham sausage or western style ham sausage of the invention is not only tasteful but also can be appreciated the existence of the aquatic animal meat. It is the true aquatic meat ham sausage or western style ham sausage, which fills the vacancy of the market.

The present invention overcomes the defect of aquatic animal meat being shaped difficultly which results from its short fibres and more moisture content. The present invention can be used in large scale, and the sources of the raw material used in the invention are broad. The invention provides a new method for processing aquatic product.

The present invention combines the advantages of good taste and high nutritive value the aquatic animal meat possessed with the advantages of easy to preserve and to carry, convenience for eating and unique in taste the conventional ham sausage or western style ham sausage possessed to provide a kind of new convenience food. Furthermore, the present invention can provide different tastes which result from different formulations, so it can satisfy different demands of consumers. Meanwhile, the present invention can solve the problem that some consumers are not expert in cooking who like eating aquatic animal meat.

### DETAILED DESCRIPTION OF THE PREFERRING EMBODIMENTS

The present invention will be further explained by the following examples.

### EXAMPLE 1

Selecting processed hairtail meat 60 kg and Todarodes pacificus (squid) 40 kg, cutting into block having length of 2-100 mm, adding salt 2.7 kg, sugar 2 kg, soya protein 6 kg, spicery 0.2 kg, cooking wine 1 kg, mixing them uniformly, filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

### EXAMPLE 2

Selecting processed pomfret meat 70 kg and Todarodes pacificus (squid) 30 kg, cutting into block having length of 2-100 mm, adding salt 2.7 kg, sugar 2 kg, soya protein 6 kg, spicery 0.2 kg, cooking wine 1 kg, mixing them uniformly, filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

### EXAMPLE 3

Selecting processed hairtail meat 92 kg and cuttlefish 8 kg, cutting into block having length of 2-100 mm, adding salt 2.7 kg, sugar 2 kg, soya protein 6 kg, spicery 0.2 kg, cooking wine 1 kg, mixing them uniformly, filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

### EXAMPLE 4

Selecting processed yellow croaker (yellow-tin tuna) meat 50 kg, cutting into block having length of 1-90 mm, and Octopus variabilis meat block 50 kg, adding soya sauce 4 kg, salt 3.5 kg, sugar 2.5 kg, cooking wine 1.5 kg, spicery 0.5 kg, mixing them uniformly, filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

### EXAMPLE 5

Selecting processed yellow croaker (yellow-tin tuna) meat 5 kg, cutting into block having length of 1-90 mm, and Todarodes pacificus (squid) meat block 95 kg, adding soy sauce 4 kg, salt 3.5 kg, sugar 2.5 kg, cooking wine 1.5 kg, spicery 0.5 kg, mixing them uniformly, filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.

### PRACTICAL APPLICABILITY

The present invention combines the advantages of good taste, high nutritive value the aquatic product possessed with the advantages of easy to preserve and carry, convenience for eating and unique in taste the conventional ham sausage or western style ham sausage possessed, and provides a kind of new convenience food. Furthermore, the product of the present invention is convenient for eating, and is helpful to people's health because of its high nutritive value.

1. Pure aquatic animal meat ham sausage or western style ham sausage containing fish, characterized in that: using minced cephalopod aquatic animal meat as a binding agent mixed with fish meat as main material, and being prepared by conventional methods after seasonings as subsidiary materials are added to the mixture, wherein the cephalopod aquatic animal meat is 8-95% of the total weight.

2. Pure aquatic animal meat ham sausage or western style ham sausage containing fish according to claim 1, wherein the said cephalopod aquatic animal meat is 30-50% of the total weight.

3. Pure aquatic animal meat ham sausage or western style ham sausage containing fish according to claim 1 or 2, wherein the said cephalopod aquatic animal includes Todarodes pacificus, Sepia esculenta, Loligo japonica, Sepiella maindroni, Doryteuthis bleekeri, Sepioteuthis lessoniana, Octopus variabilis, Octopus ochellatus and Octopus vulgaris.

4. Pure aquatic animal meat ham sausage or western style ham sausage containing fish according to claim 1 or 2, wherein the process of the cephalopod aquatic animal meat includes steps: rough processing, removing inedible portion, then cutting edible portion into block, strip, slice or particle with length of 2-100 mm, width of 2-100 mm and thickness of 2-40 mm; and then curing them with suitable amount of seasonings for 2-48 hours.

5. Pure aquatic animal meat ham sausage or western style ham sausage containing fish according to claim 1 or 2, wherein the said fish is fish mash or fish block.

6. Pure aquatic animal meat ham sausage or western style ham sausage containing fish according to claim 5, in which the method for preparing the said fish block includes steps: selecting a certain amount of fish to be rough processed, removing head, gut, and scale, then salting the fish with salt or curing the fish with seasonings, drying the salted or cured fish by airing in shady and cool place or by heating, steaming the dried fish for 15-30 minutes, removing fish bone and foreign materials after cooling, and then cutting the fish into block, strip or slice with length of 2-100 mm, thickness of 2-40 mm and width of 2-100 mm.

7. Pure aquatic animal meat ham sausage or western style ham sausage containing fish according to claim 5, in which the method for preparing said fish block includes steps: rough processing, removing head, gut and scale, curing the fish with water, salt and spicery for 0.5-12 hours, removing inedible portion after steaming or cooking, and then cutting the edible portion into block, strip or slice with length of 2-100 mm, thickness of 2-40 mm and width of 2-100 mm.

8. Pure aquatic animal meat ham sausage or western style ham sausage containing fish according to claim 6 or 7, wherein the said fish block is raw, ready-cooked, smoked and/or dried product.

9. Pure aquatic animal meat ham sausage or western style ham sausage containing fish according to claim 1 or 2, wherein the weight ratios of the subsidiary materials are: refined salt 0.5-5, soya sauce 0-8, sugar 1-10, soya protein or starch 0-8, carrageenan 1-5, spicery 0.01-5, thickener 0.01-5.

10. A process for preparing the pure aquatic animal meat ham sausage or western style ham sausage containing fish according to claim 1 or 2, characterized in that: selecting a certain amount of cephalopod aquatic animal meat to be rough processed, removing inedible portion, cutting edible portion into block, strip, slice or particle with length of 2-100 mm, thickness of 2-40 mm and width of 2-100 mm, then curing the fish with suitable amount of seasonings for 2-48 hours, mixing the processed cephalopod aquatic animal meat with the fish meat, in which the cephalopod aquatic animal meat is 8-95% of the total weight; and then adding the subsidiary materials in light of different tastes, mixing the above raw materials uniformly and filling the mixture into simulation casing by vacuum filling machine, and sealing the two open ends by U-shaped or [symbol] -shaped clips, and then steaming or boiling adequately and being sterilized in boiler or autoclave, finally cooling and drying to obtain the ham sausage or western style ham sausage according to this invention.
